(19) United States
(12) Patent Application Publication
(10) Pub. No.: US 2025/0265412 A1
(43) Pub. Date: Aug. 21, 2025

(54) DYNAMIC DEPENDENCY DETECTION AND ADAPTION SYTEM

(71) Applicant: Bank of America Corporation, Charlotte, NC (US)

(72) Inventors: Ramesh Anantarapu, Hyderabad Telangana (IN); Sreeram Raghavan, Chennai Tamil Nadu (IN)

(21) Appl. No.: 18/442,410

(22) Filed: Feb. 15, 2024

(51) Int. Cl. G06F 40/284; G06F 40/40

(52) U.S. Cl. CPC G06F 40/284; G06F 40/40

(57) ABSTRACT

A system for continuous system adaption comprising a receiver, a data processor and an artificially-intelligent (“AI”) engine. The receiver may receive a structure map of an in-use computing environment. The structure map may include details relating to feature sets and dependencies between features sets. The receiver may receive a new set of guidelines for implementation in the in-use computing environment. The data processor may process the new set of guidelines and the structure map into a vocabulary. The AI engine may extract vectorized features from the vocabulary and categorize the features as impacted or unimpacted. The AI engine may simulate, using a quantum simulator, parameter and feature combinations to stabilize the impacted features when evaluated alongside the new set of guidelines. The AI engine may, based on the simulation, output a set of changes to be implemented to the features within the in-use computing environment.

### FIELD OF TECHNOLOGY

Aspects of the disclosure relate to simulators.

### BACKGROUND OF THE DISCLOSURE

Entities may create various documents and/or computer programs based on one or more rules and regulations. These rules and regulations may indicate specific guidelines on offerings the entities may provide their customers. The rules and regulations may vary from one geographical region to another geographical region. The rules and regulations may change frequently.

At times, rules and regulations are modified. It may be challenging to identify whether the existing documents and/or computer programs comply with the modified rules. It may also be challenging to identify whether the documentation and/or computer programs can be adapted to comply with the modified rules or whether the documentation and/or computer programs involve replacement to comply with the modified rules.

It would be desirable to provide a deep learning-based impact analysis system. It would be desirable for the system to determine modification impact. It would be further desirable for the system to determine guidelines necessitated by the modified rules and regulations. It would be desirable for such guidelines to be based on a comparison between modified rules and regulations and existing documentation and computer programs.

### SUMMARY OF THE DISCLOSURE

Systems, apparatus and methods for dynamic intra-system component dependency detection, intra-system component impact detection, computing environment adaption and computing environment remediation may be provided.

Impact analysis may be executed by overlaying a set of system changes on an existing computing environment. The existing computing environment may include one or more sets of documentation and/or computer programs. The impact analysis may utilize a comprehensive understanding of a plurality of features related to, and/or included in, the documentation and/or computer programs. As such, a clear understanding of both the existing system and the set of changes may be identified prior to executing the impact analysis and system remediation.

In order to fully appreciate the existing computing environment, the system may identify and evaluate dependencies within the computing environment. For the purposes of this application, dependencies may be understood to refer to software and/or hardware elements that depend on, or retrieve data from, other software and/or hardware elements. Software and/or hardware elements may include servers, databases, features, applications, personal computers and mobile devices. An example of a dependency follows: server A may communicate with servers B, C and D. Server B may communicate with server E. As such, servers B, C, D and E may represent dependencies of server A. It should be noted that servers B, C and D may represent first level dependencies of server A, while server E may represent a second level dependency on server A.

The system may compare, or identify a delta between, the current computing environment and the new guidelines. Based on the identified delta, the system may also identify changes to be made to the dependencies. The system may scale and analyze relevance of the identified changes.

The system may be a deep learning-based inference and rationalization system. As such, a deep learning system may identify dependencies impacted by a set of changes and/or guidelines. Such a deep learning system may also compare the impacted dependencies to one or more enterprise standard benchmarks. Such a deep learning system may also identify additional changes to be executed in a computing environment to ensure that the computing environment is compatible with both legacy guidelines and current guidelines. Such a deep learning system may utilize a suitable computer language such as Python 3.10 and TensorFlow.

The deep learning system may be an end-to-end processing platform that identifies and interprets the relevance and impact of new guidelines as overlayed on a plurality of dependencies included in the computing environment. The deep learning system may rationalize, determine and identify a set of changes to be implemented on one or more current computing environments. The deep learning system may consider scalability guidelines from an enterprise perspective when identifying the set of changes. The deep learning system may produce documentation that complies with the set of changes. The deep learning system may implement the set of changes within the computing environment.

The deep learning system may identify dependencies between features. The dependencies may be at an individual level and/or a holistic level using a plurality of parametrized methods. The system may provide intelligent reasoning for one or more changes included in the set of changes. The intelligent reasoning may be based on one or more technical stack scalability parameter boundaries. The boundaries may be established at an enterprise level. The intelligent reasoning may be used to identify the set of changes and/or the intelligent reasoning may be used in combination with the set of changes. The intelligent reasoning and/or the set of changes may be used to generate documentation relating to the set of changes.

The deep learning system may determine data-based processing protocols. The data-based processing protocols may enable a hybrid sampling process. The hybrid sampling process may process parameters that may be impacted by the new guidelines.

The deep learning system may process adoption of new parameters through adaptive reinforcement learning. Adaptive reinforcement learning may enable the deep learning system to consider relationships between and across parameters. Adaptive reinforcement learning may process the relationships between and across parameters in an iterative pattern.

The deep learning system may use non-deterministic output rationalization to evaluate and verify one or more (in some instances, substantially all) potential outcomes to identify an appropriate parameter fit for the set of changes.

The deep learning system may identify whether the defined parameters are sufficient to identify a converged and appropriate policy. The deep learning system may also identify whether the defined parameters are sufficient to promote parameter improvement.

A system for continuous system adaption may be provided. The system may include a receiver, a data processor and an artificially-intelligent engine.

The receiver may be operable to receive a structure map of an in-use computing environment. The structure map may include details relating to one or more feature sets and details relating to one or more dependencies between features included in the one or more feature sets.

The receiver may be operable to receive a set of new guidelines. The new set of guidelines may be for implementation in the in-use computing environment.

The data processor may be a natural language processing engine. The data processor may be operable to tokenize the structure map and the set of new guidelines into a first plurality of words directed to the structure map and a second plurality of words directed to the set of new guidelines. The data processor may be operable to create, using a large language model, a vocabulary from the first plurality of words and the second plurality of words. The data processor may be operable to pad and assign sequence length to the first plurality of words and second plurality of words included in the vocabulary.

The artificially-intelligent engine operable to extract, using an autoencoder, a set of vectorized features from the vocabulary. The artificially-intelligent engine may be operable to categorize features included in the one or more feature sets as impacted or unimpacted. The artificially-intelligent engine may be operable to simulate, using a quantum simulator, substantially all possible parameter and feature combinations to stabilize the impacted features when evaluated alongside (or overlayed on) the new set of guidelines. The artificially-intelligent engine may be operable to identify a set of changes to be made to the one or more features sets based on the simulation.

The artificially-intelligent engine may grade, at a second quantum simulator, a complexity of the set of changes to made to the one or more features sets.

The artificially-intelligent engine may re-identify a set of changes to be made to the one or more features sets based on the grade. The artificially-intelligent engine may identify, at a third quantum simulator, a degree of change compelled by the in-use computing environment to comply with the set of changes. The artificially-intelligent engine may re-identify a set of changes to be made to the one or more features sets based on the degree of change. The artificially-intelligent engine may output the set of changes as a final set of changes to be made to the in-use computing environment.

The artificially-intelligent engine may implement the final set of changes within the in-use computing environment.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows another illustrative diagram in accordance with principles of the disclosure; and

FIG. 4 shows another illustrative diagram in accordance with principles of the disclosure.

### DETAILED DESCRIPTION OF THE DISCLOSURE

Apparatus, systems and methods for continuous system adaption are provided. Methods may include a data gathering stage, a data processing stage and a machine learning stage.

At the data gathering stage, methods may include receiving a structure map of an in-use computing environment. An in-use computing environment may include one or more hardware elements (such as servers and computers). An in-use computing environment may also include one or more software elements (such as applications, features and parameters). The structure map may include one or more sets of features. The structure map may also include one or more dependencies between features included in the sets of features. It should be noted that the structure map of the in-use computing environment may describe the computing environment and relationships between hardware and software elements included in the computing environment.

The data gathering stage may also include receiving a set of new guidelines. The set of new guidelines may be for implementation in the in-use computing environment. The set of new guidelines may be received from an entity source. The set of new guidelines may be based on a geographic location of the in-use computing environment. The set of new guidelines may apply to a portion of the in-use computing environment. Examples of a set of new guidelines may include all payment transactions should be conducted within a specific geographic area (for example, a host country). Another example of a set of new guidelines may include that payments can be processed anywhere in the world, however, within 24 hours of payment processing, all of the payment documentation should be imported to the host country. Another example of a set of new guidelines may include certain fields included in a payment may be stored out of the host country, other fields may not be stored out of the host country.

The data processing stage may include tokenizing the structure map and the set of new guidelines into a first plurality of words and a second plurality of words. The first plurality of words may be directed to the structure map. The second plurality of words may be directed to the set of new guidelines. In some embodiments, the structure map may be tokenized into a first plurality of grams. The structure map may be tokenized into a second plurality of grams. A gram may represent an alphanumeric combination or a word. A gram may also be referred to as an n-gram, where n represents the number of words included in the gram.

The data processing stage may include creating, using a large language model, a vocabulary, from the tokenized structure map and the tokenized set of new guidelines. The vocabulary may include the first plurality of words and the second plurality of words.

The data processing stage may include pre-contextually embedding the first plurality of words and the second plurality of words included in the vocabulary. The data processing stage may include padding and assigning sequence length to the first plurality of words, or grams, and the second plurality of words, or grams, included in the vocabulary.

The data processing stage may include inputting the vocabulary into an artificially-intelligent engine.

The machine learning stage may be executed at the artificially-intelligent engine. The machine learning stage may include extracting a set of vectorized features. The vectorized features may be extracted from the vocabulary.

The extracting may be processed by an autoencoder. The autoencoder may be a stacked convolutional autoencoder. The autoencoder may be located within the artificially-intelligent engine. The autoencoder may be located external to the artificially-intelligent engine. The autoencoder may iteratively scale down each inputted element, included in a set of input elements, to a lowest dimension (also referred to as, a “bottleneck layer” or “lowest possible dimension”). The autoencoder may recreate each input element included in the set of input elements until the set of input elements is reproduced at an output layer of the autoencoder. The autoencoder may extract, from the bottleneck layer, the set of vectorized features.

The machine learning stage may include visually classifying and categorizing features, within the set of vectorized features, that are closely related to each other. A t-distributed stochastic neighbor embedding model within the artificially-intelligent engine may execute the visual classifying and categorizing.

The machine learning stage may include categorizing objects within the structure map as impacted or unimpacted. The machine learning stage may also include categorizing each feature, included in the one or more sets of features. As such, the objects may include the one or more sets of features. A two-class classifier located within the artificially-intelligent engine may execute the categorizing.

The machine learning stage may also include simulating, at a quantum engine, substantially all possible parameter and feature combinations. The machine learning stage may also include simulating, at the quantum engine, substantially all combinations of features included in the one or more sets of features and all combinations of one or more parameters assignable to features included int eh one or more sets of features.

The machine learning stage may also include identifying, at the quantum engine, resource consumption of each of the combinations at a quantum simulator within the quantum engine. The identifying may be based on the simulating.

The machine learning stage may also include, based on the simulating, grading, at the quantum engine, a complexity of a set of changes to be made to the one or more sets of features at a complexity gradient simulator within the quantum engine. The machine learning stage may also include, based on the simulating, identifying, at the quantum engine, a degree of change compelled by the in-use computing environment to comply with the set of changes at a diversity analyzer simulator within the quantum engine. The machine learning stage may also include splitting the combinations into multiple states of existence using a plurality of rules at a controller. The machine learning stage may also include splitting the combinations of features into multiple states of existence using a plurality of rules at a controller. The controller may be located within the quantum engine.

The machine learning stage may also include outputting one or more mutually exclusive states from the controller. The machine learning stage may also include processing each of the one or more mutually exclusive states at a state processing engine within the quantum engine. The machine learning stage may also include outputting a final recommendation from the state processing engine within the quantum engine. The machine learning stage may also include inputting the final recommendation to a transformer neural network. The machine learning stage may also include processing the final recommendation at the transformer neural network. The final recommendation may include an assignable parameter for each feature. The machine learning stage may also include outputting, from the transformer neural network, a final set of changes to the in-use computing environment. The final set of changes may include one or more features to be maintained within the in-use computing environment, one or more features to be added to the in-use computing environment, one or more features to be deleted from the in-use computing environment and/or one or more parameters assignable to each feature to be maintained or added within the in-use computing environment.

The method may include implementing the final set of changes within the in-use computing environment.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

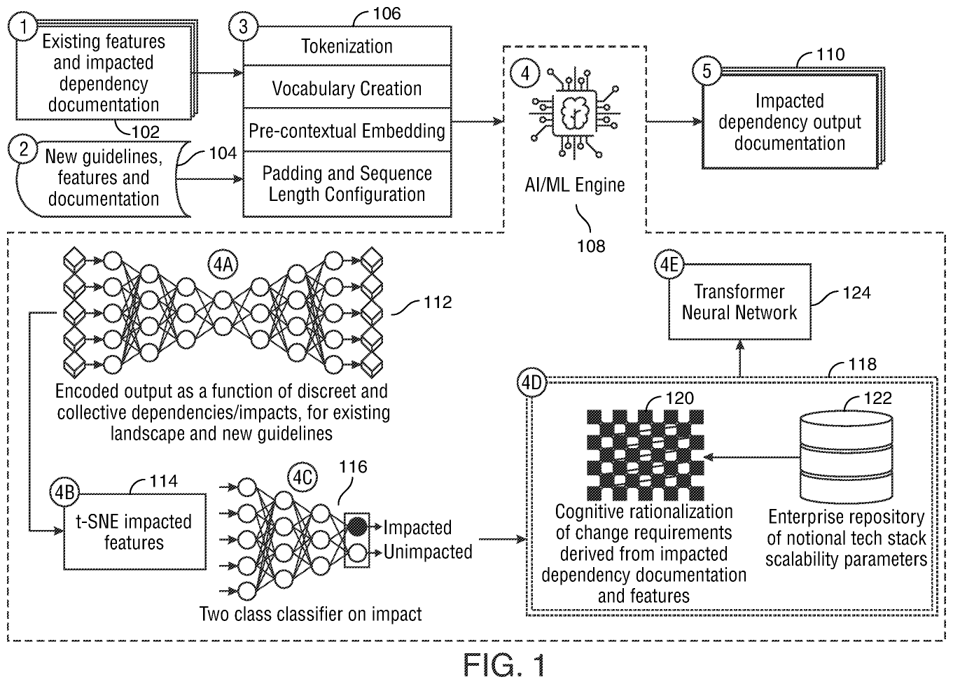

FIG. 1 shows a system diagram.

Step 1, shown at 102, shows retrieval/receipt of an existing set of features, impacts of the existing set of features, the dependencies between those features and the documentation related to the existing set of systems.

Step 2, shown at 104, shows retrieval/receipt of a new set of guidelines. Additionally, step 2 includes features affected by the new set of guidelines. The features that are impacted by the new set of guidelines may include one or more impacted fields. At times, the attributes of the fields may be impacted. Attributes of the fields may include types of the fields. Types of the fields may include a string type, a numerical type, an enumerated type, a date type or any other suitable field type. All of the information relating to the existing features and the new guidelines may be retrieved in steps 1 and 2. It should be noted that the data retrieved in step 1 may be legacy data, while the data retrieved in step 2 may be new data.

In step 3, shown at 106, the data retrieved in steps 1 and 2 may be preprocessed using a set of sequence processing guidelines. The sequence processing guidelines include tokenization (separating the data into a plurality of word grams), using a large language model (“LLM”) for vocabulary creation, pre-contextual embedding and padding and sequence length configuration. The padding and sequence length configuration may ensure that the input that is fed into the artificial intelligence/machine learning (“AI/ML”) engine (shown at 108) is uniform in length.

Step 4, shown at 108, shows the AI/ML engine. Step 4 may have multiple secondary steps, including step 4A, shown at 112, step 4B, shown at 114, step 4C, shown at 116, step 4D, shown at 118 and step 4E, shown at 124.

Step 4A shows an autoencoder. Using convolutional layers, the autoencoder may be able to extract each of the received features. The autoencoder may continually scale down each of the features to the lowest possible dimension. At one point, the autoencoder may scale down to a minimum level. The minimum level may be referred to as the bottleneck. At the bottleneck, it may be possible to re-extract these features and recreate the original set of features. This process may be repeated iteratively until the following threshold is met: the input is reproduced exactly at the output layer. When the threshold is met, vectorized features may be extracted from the bottleneck layer. The process may use a stacked convolutional autoencoder. The reason for using a stacked autoencoder may include that multiple layers of input followed by a corresponding layer of output may enable one to identify the bare minimum of features/components that may be used in a system. The output of the autoencoder may be passed to step 4B.

Step 4B shows a t-SNE (t-distributed stochastic neighbor embedding) model. A t-SNE model may include statistical method for visualizing high-dimensional data by assigning each datapoint a location in a map. The map may include multiple dimensions, such as two, three or any other suitable number of dimensions. The t-SNE model may be used to visually classify and categorize the features which are closely related to each other. The output of the t-SNE may be passed to step 4C.

Step 4C shows a two-class classifier. The two-class classifier may categorize an object as impacted or non-impacted. The object may be a feature, a document or any other suitable object.

An example of a feature that may be classified as unimpacted may be explained in the following example. A guideline may state that whenever interest is calculated and a payout is made to a specific customer, the system may have to ensure to round it off to the nearest dollar before the payout has completed processing. The system may include multiple features. One set of features may be related to customer demographics. This set of features may include, for example, customer name, customer address and customer telephone number. This set of features regarding the customer demographics may be stored in a specific database. This set of features regarding customer demographics may be labeled as “unimpacted” by the interest calculations guideline. Impacted features may include features that involve, or are associated with, interest calculation. The set of unimpacted objects may be discarded at step 4C. The set of impacted objects is input into step 4D, shown at 118.

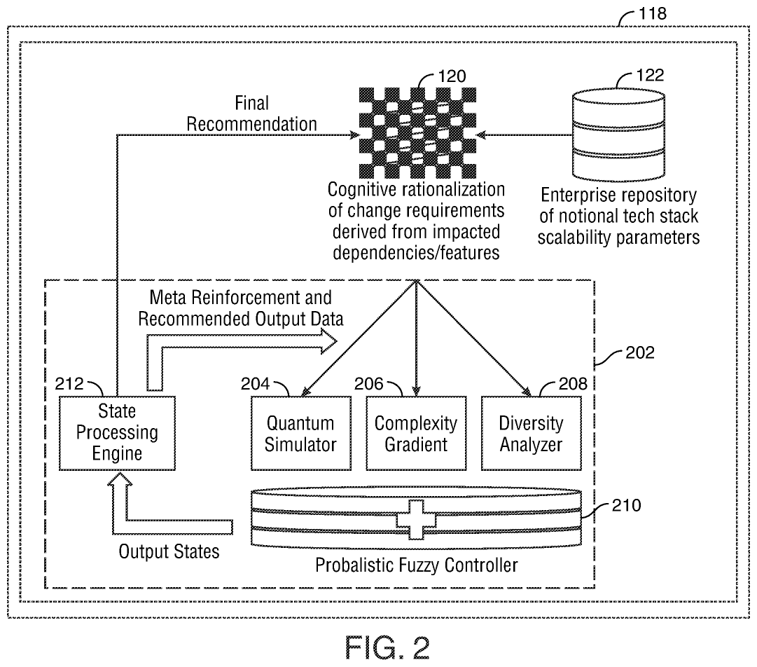

Step 4D, shown at 118, may receive the set of impacted objects. Step 4D shows a cognitive rationalization engine, shown at 120. The engine includes a plurality of features are attributes which are inputted into the rationalization engine. This rationalization engine may also receive a technical stack of applicable parameters which are inputted into the rationalization engine, as shown at 122. The technical stack may define parameters that include a set of outer boundaries which define the minimum and maximum values which are used for defining a guideline. An example of a parameter and an outer boundary may be a specific server that cannot be powered off/offline/out of service for more than thirty minutes. A series of conditions may be a parameter defined within the technical stack. These parameters may also be input into the rationalization engine, shown at 120. The details of the rationalization engine may be shown in FIG. 2.

Step 4E, shown at 124, may include a transformer neural network. The output of the rationalization engine, shown at 120, may be input into a transformer neural network, shown at 124. The transformer neural network may process the final recommendation into a plurality of impacted dependency output documents. The output of the transformer neural network, shown at 124, may be the output of the AI/ML engine 108. Step 5, shown at 110, may include the output of the AI/ML engine 108, which may include a list of impacted dependency output documentation.

FIG. 2 shows a system diagram. The system diagram may include components of step 4D shown in FIG. 1. Cognitive rationalization engine 120 may be a quantum engine with a plurality of simulators. Cognitive rationalization engine 120 may include a quantum simulator 204, a complexity gradient 206 and a diversity analyzer 208. Engine 120 may pass a plurality of parameters to quantum simulator 204. Quantum simulator 204 may include a series of simulators.

Depending on one or more data parameters, one or more elements of data may be passed to engine 120. Engine 120 may reside inside AI/ML engine 108. When data elements are passed into the rationalization engine, AI/ML engine 108 may identify the type of data being received. Based on the type of data received, AI/ML engine 108 may engage a different simulator. In one example, AI/ML engine 108 is tasked with evaluating the resource consumption cost and time of different parameter and/or feature combinations. As such, AI/ML engine may select a quantum simulator. In a second example, AI/ML engine 108 is tasked with grading the complexity of the set of changes to be made to the features. An exemplary grading system may be simple, medium or complex. As such, AI/ML engine 108 may select a complexity gradient analyzer. In a third example, AI/ML engine 108 is tasked to identify a degree of change identified by the existing system to comply with the set of changes. The degree of changes may be measured by the number of features and/or parameters that involve adjustment. As such, the AI/ML engine 108 may select a diversity analyzer (also referred to as a differential analyzer).

Based on the type of data being received, a different protocol may be selected by the quantum engine. The quantum engine may select the protocol for the purpose of identifying each combination that is being simulated. Based upon the combination of data, cost and time may be analyzed at 204, degree of complexity may be analyzed at 206 and the extent to which a change has to be made is analyzed at 208.

In a quantum machine, using qubit-based representation, each of the combinations may become a separate representation. If a single feature may be assigned five different values and six different parameters, the result is a minimum possibility of thirty different combinations. There may also be in-between states as well. Because quantum machines have the ability to identify the in-between states, an expected output of each of the combinations may be identified. At times, based on the number of parameters used to execute the rationalization, possible combinations can total thousands or millions.

The creation of various combinations may be executed using substantially all of the relevant parameters. This may be an advantage over testing a single parameter.

In order to process the combinations at the next stage, the combinations may be split into multiple states of existence. Splitting the combinations into multiple states of existence may be achieved using fuzzy rules, included in probabilistic fuzzy controller 210. Using fuzzy rules, it may be possible to establish multiple mutually exclusive states. Each of these states may have a particular threshold for categories.

Rule reference engines may be used to establish a boundary for each metric included in each category. Examples of metrics may be ranges, such as 0-1000 or 0-1000000. A metric may be any set of values. Probabilistic fuzzy controller 210 may be adaptable to manage any range of values received for each of the parameters. The boundaries may change according to the parameters. Boundary conditions may be established for each of the parameters. Using probabilistic fuzzy controller 210, each output state may be outputted to state processing engine 212.

State processing engine 212 may initially retrieve the output states and determine which combination is most efficient. The AI/ML engine may involve an iterative learning process, whereby it may understand how the outputs of state processing engine 212 match with a plurality of other outputs. The iterative learning process may be indicated at meta reinforcement and recommended output data.

When the AI/ML engine identifies a convergence (or match) between the values identified at the system and a second set of values received from a second system, it may iterate through the parameters multiple times. Each iteration may recalibrate the values for the different parameters. During the iterative process, the AI/ML engine may identify whether a parameter compels a complete change. For example, the engine may identify, using a complexity scale ranging from 1-5, that it may be possible to receive an output that does not match the output of the second output. As such, the system may split the complexity level into seven different complexity stages. A scale of seven complexity stages may enable selection of complexity stage seven. Complexity stage seven may provide a convergence with the second output. As such, the AI/ML engine may identify a parameter that necessitates recalibration. This learning continues proceeding through the quantum simulator (204), complexity gradient (206) and diversity analyzer (208) until the most appropriate convergence is achieved. The most appropriate convergence may be identified as a final recommendation. The final recommendation may be input into rationalization engine 120.

The final recommendation may be input from the rationalization engine into a transformer neural network, shown at 124. Transformer neural network 124 may read the final recommendation and prepare the document.

Each time a new guideline is received, the new guideline may be passed to AI/ML engine 108. AI/ML engine 108 may output a recommendation. At times, AI/ML engine 108 may implement the set of changes in the system.

Additionally, testing may be performed on AI/ML engine 108 to ensure that an unsuitable recommendation is not being recommended. Additionally, AI/ML engine 108 may document protocol and parameter changes that should be implemented so that the protocol repository is updated accordingly.

It should be noted that using a quantum simulator to identify the various states for a parameter change may increase processing speed.

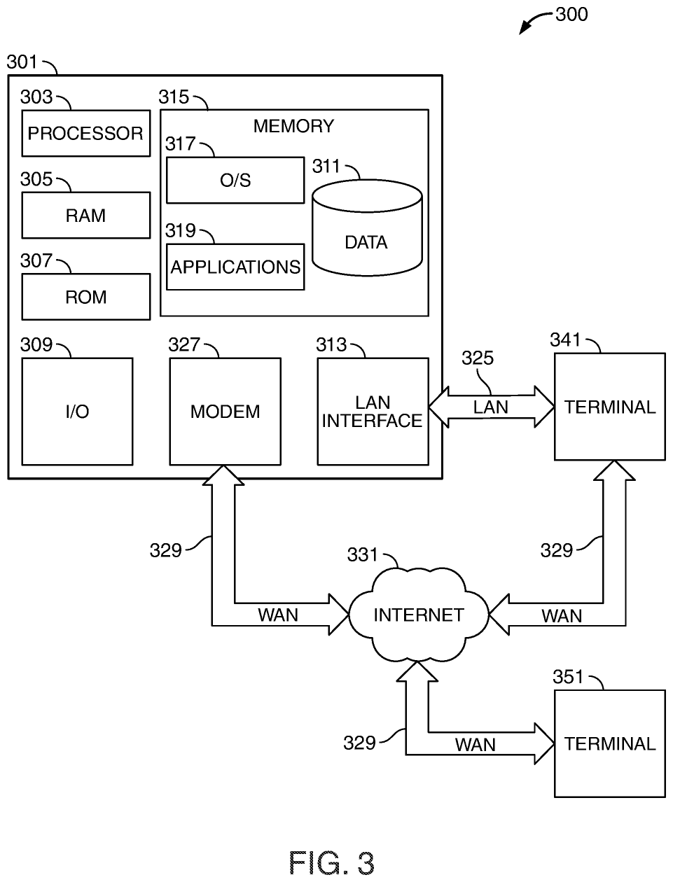

FIG. 3 shows an illustrative block diagram of system 300 that includes computer 301. Computer 301 may alternatively be referred to herein as an “engine,” “server” or a “computing device.” Computer 301 may be a workstation, desktop, laptop, tablet, smart phone, or any other suitable computing device. Elements of system 300, including computer 301, may be used to implement various aspects of the systems and methods disclosed herein. Each of the user telephones, mobile devices, user devices, databases and any other part of the disclosure may include some or all of apparatus included in system 300.

Computer 301 may have a processor 303 for controlling the operation of the device and its associated components and may include Random Access Memory (“RAM”) 305, Read Only Memory (“ROM”) 307, input/output circuit 309 and a non-transitory or non- volatile memory 315. Machine-readable memory may be configured to store information in machine-readable data structures. The processor 303 may also execute all software executing on the computer—e.g., the operating system and/or voice recognition software. Other components commonly used for computers, such as EEPROM or Flash memory or any other suitable components, may also be part of the computer 301.

Memory 315 may be comprised of any suitable permanent storage technology—e.g., a hard drive. Memory 315 may store software including the operating system 317 and application(s) 319 along with any data 311 needed for the operation of the system 300. Memory 315 may also store videos, text and/or audio assistance files. Nodes, servers, computing devices, user telephones, user devices, databases and any other suitable computing devices as disclosed herein may have one or more features in common with Memory 315. The data stored in Memory 315 may also be stored in cache memory, or any other suitable memory.

Input/output (“I/O”) module 309 may include connectivity to a microphone, keyboard, touch screen, mouse and/or stylus through which input may be provided into computer 301. The input may include input relating to cursor movement. The input/output module may also include one or more speakers for providing audio output and a video display device for providing textual, audio, audiovisual and/or graphical output. The input and output may be related to computer application functionality.

System 300 may be connected to other systems via a local area network (“LAN”) interface 313. System 300 may operate in a networked environment supporting connections to one or more remote computers, such as terminals 341 and 351. Terminals 341 and 351 may be personal computers or servers that include many or all of the elements described above relative to system 300. When used in a LAN networking environment, computer 301 is connected to LAN 325 through a LAN interface or adapter 313. When used in a Wide Area Network (“WAN”) networking environment, computer 301 may include a modem 327 or other means for establishing communications over WAN 329, such as Internet 331. Connections between System 300 and Terminals 351 and/or 341 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 319, which may be used by computer 301, may include computer executable instructions for invoking functionality related to communication, such as e-mail, Short Message Service (“SMS”) and voice input and speech recognition applications. Application program(s) 319 (which may be alternatively referred to herein as “plugins,” “applications,” or “apps”) may include computer executable instructions for invoking functionality related to performing various tasks. Application programs 319 may utilize one or more algorithms that process received executable instructions, perform power management routines or other suitable tasks. Application programs 319 may utilize one or more decisioning processes.

Application program(s) 319 may include computer executable instructions (alternatively referred to as “programs”). The computer executable instructions may be embodied in hardware or firmware (not shown). Computer 301 may execute the instructions embodied by the application program(s) 319 to perform various functions.

Application program(s) 319 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 311 and any other suitable information, may be stored in memory 315. One or more of applications 319 may include one or more algorithms that may be used to implement features of the disclosure comprising the transmission, storage, and transmitting of data and/or any other tasks described herein.

The invention may be described in the context of computer-executable instructions, such as applications 319, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 301 and/or terminals 341 and 351 may also include various other components, such as a battery, speaker and/or antennas (not shown). Components of computer system 301 may be linked by a system bus, wirelessly or by other suitable interconnections. Components of computer system 301 may be present on one or more circuit boards. In some embodiments, the components may be integrated into a single chip. The chip may be silicon-based.

Terminal 351 and/or terminal 341 may be portable devices such as a laptop, cell phone, tablet, smartphone, or any other computing system for receiving, storing, transmitting and/or displaying relevant information. Terminal 351 and/or terminal 341 may be one or more data sources or a calling source. Terminals 351 and 341 may have one or more features in common with apparatus 301. Terminals 315 and 341 may be identical to system 300 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

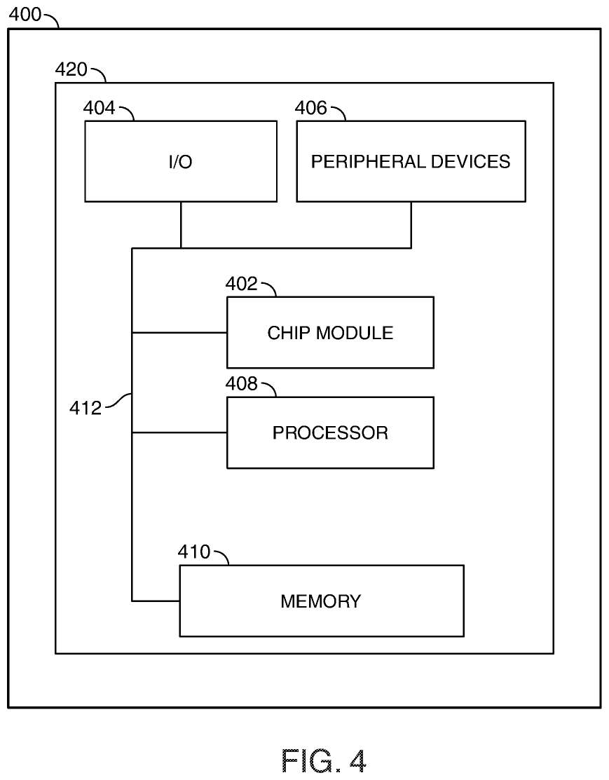

FIG. 4 shows illustrative apparatus 400 that may be configured in accordance with the principles of the disclosure. Apparatus 400 may be a computing device. Apparatus 400 may include one or more features of the apparatus shown in FIG. 3. Apparatus 400 may include chip module 402, which may include one or more integrated circuits, and which may include logic configured to perform any other suitable logical operations.

Apparatus 400 may include one or more of the following components: I/O circuitry 404, which may include a transmitter device and a receiver device and may interface with fiber optic cable, coaxial cable, telephone lines, wireless devices, PHY layer hardware, a keypad/display control device or any other suitable media or devices; peripheral devices 406, which may include counter timers, real-time timers, power-on reset generators or any other suitable peripheral devices; logical processing device 408, which may compute data structural information and structural parameters of the data; and machine-readable memory 410.

Machine-readable memory 410 may be configured to store in machine-readable data structures: machine executable instructions, (which may be alternatively referred to herein as “computer instructions” or “computer code”), applications such as applications 419, signals and/or any other suitable information or data structures.

Components 402, 404, 406, 408 and 410 may be coupled together by a system bus or other interconnections 412 and may be present on one or more circuit boards such as 420. In some embodiments, the components may be integrated into a single chip. The chip may be silicon-based.

Thus, systems and methods for dynamic dependency detection and adaption are provided. Persons skilled in the art will appreciate that the present invention can be practiced by other than the described embodiments, which are presented for purposes of illustration rather than of limitation. The present invention is limited only by the claims that follow.

What is claimed is:

1. A method for continuous system adaption, the method comprising:
at a data gathering stage:
receiving a structure map of an in-use computing environment, the structure map of the in-use computing environment involving:
one or more sets of features; and
one or more dependencies between features included in the one or more sets of features;
receiving a set of new guidelines, the set of new guidelines for implementation in the in-use computing environment;
at a data processing stage:
tokenizing the structure map and the set of new guidelines into a first plurality of words directed to the structure map and a second plurality of words directed to the set of new guidelines;
creating, using a large language model, a vocabulary, from the tokenized structure map and the tokenized set of new guidelines, said vocabulary comprising the first plurality of words and the second plurality of words;
pre-contextually embedding the first plurality of words and the second plurality of words included in the vocabulary;
padding and assigning sequence length to the first plurality of words and the second plurality of words included in the vocabulary;
inputting the vocabulary into an artificially-intelligent engine;
at a machine learning stage, at the artificially-intelligent engine:
at an autoencoder located within the artificially-intelligent engine, extracting a set of vectorized features;
visually classifying and categorizing features, within the set of vectorized features, that are closely related to each other;
at a two-class classifier located within the artificially-intelligent engine, categorizing objects within the structure map as impacted or unimpacted;
at a quantum engine:
simulating substantially all possible parameter and feature combinations; and
based on the simulating, identifying resource consumption of each of the combinations at a quantum simulator within the quantum engine;
based on the simulating, grading a complexity of a set of changes to be made to the one or more sets of features at a complexity gradient simulator within the quantum engine; and
based on the simulating, identifying a degree of change compelled by the in-use computing environment to comply with the set of changes at a diversity analyzer simulator within the quantum engine;
splitting the combinations into multiple states of existence using a plurality of rules at a controller within the quantum engine;
outputting one or more mutually exclusive states from the controller;
processing each of the one or more mutually exclusive states at a state processing engine within the quantum engine;
outputting a final recommendation from the state processing engine within the quantum engine;
inputting the final recommendation to a transformer neural network;
processing the final recommendation at the transformer neural network; and
outputting, from the transformer neural network, a final set of changes to the in-use computing environment.

2. The method of claim 1 further comprising implementing the final set of changes within the in-use computing environment.

3. The method of claim 1 wherein the autoencoder:
iteratively scales down each inputted element, included in a set of input elements, to a lowest possible dimension (referred to as, a “bottleneck layer”) and recreates each input element included in the set of input elements until the set of input elements is reproduced at an output layer of the autoencoder; and
extracts, from the bottleneck layer, the set of vectorized features.

4. The method of claim 3 wherein the autoencoder is a stacked convolutional autoencoder.

5. The method of claim 1 wherein a t-distributed stochastic neighbor embedding model within the artificially-intelligent engine executes the visually classifying and categorizing features.

6. A method for continuous system adaption, the method comprising:
at a data gathering stage:
receiving a structure map of an in-use computing environment, the structure map of the in-use computing environment involving:
one or more sets of features; and
one or more dependencies between features included in the one or more sets of features;
receiving a set of new guidelines, the set of new guidelines for implementation in the in-use computing environment;
at a data processing stage:
tokenizing the structure map into a first plurality of grams;
tokenizing the set of new guidelines into a second plurality of grams;
creating, using a large language model, a vocabulary, from the first plurality of grams and the second plurality of grams;
padding and assigning sequence length to the first plurality of grams within the vocabulary;
padding and assigning sequence length to the second plurality of grams within the vocabulary;
inputting the vocabulary into an artificially-intelligent engine;
at a machine learning stage, at the artificially-intelligent engine:
at an autoencoder located within the artificially-intelligent engine, extracting a set of vectorized features from the vocabulary;
visually classifying and categorizing features, within the set of vectorized features, that are closely related to each other;
at a two-class classifier located within the artificially-intelligent engine, categorizing each feature, included in the one or more sets of features, within the structure map as impacted or unimpacted;
at a quantum engine:
simulating substantially all combinations of features included in the one or more sets of features and all combinations of one or more parameters assignable to features included in the one or more sets of features;
identifying resource consumption of each of the combinations of features;
splitting the combinations of features into multiple states of existence using a plurality of rules at a controller within the quantum engine;
outputting one or more mutually exclusive states from the controller;
processing each of the one or more mutually exclusive states at a state processing engine within the quantum engine;
outputting a final recommendation from the state processing engine within the quantum engine, said final recommendation comprising an assignable parameter for each feature;
inputting the final recommendation to a transformer neural network;
processing the final recommendation at the transformer neural network; and
outputting, from the transformer neural network, a final set of changes to the in-use computing environment.

7. The method of claim 6, wherein the quantum engine grades a complexity of a set of changes to be made to the one or more sets of features.

8. The method of claim 6, wherein the quantum engine identifies a degree of change compelled by the in-use computing environment to comply with each of the one or more mutually exclusive states.

9. The method of claim 6 further comprising implementing the final set of changes at the in-use computing environment.

10. The method of claim 6 wherein the autoencoder:
iteratively scales down each inputted element, included in a set of input elements, to a lowest possible dimension (referred to as, a “bottleneck layer”) and recreates each input element included in the set of input elements until the set of input elements is reproduced at an output layer of the autoencoder; and
extracts, from the bottleneck layer, the set of vectorized features.

11. The method of claim 10 wherein the autoencoder is a stacked convolutional autoencoder.

12. The method of claim 6 wherein a t-distributed stochastic neighbor embedding model within the artificially-intelligent engine executes the visually classifying and categorizing features.

13. A system for continuous system adaption, the system comprising:
a receiver operable to receive:
a structure map of an in-use computing environment, the structure map comprising:
details relating to one or more feature sets;
details relating to one or more dependencies between features included in the one or more feature sets; and
a set of new guidelines, the new set of guidelines for implementation in the in-use computing environment;
a data processor operable to:
tokenize the structure map and the set of new guidelines into a first plurality of words directed to the structure map and a second plurality of words directed to the set of new guidelines;
create, using a large language model, a vocabulary from the first plurality of words and the second plurality of words; and
pad and assign sequence length to the first plurality of words and second plurality of words included in the vocabulary;
an artificially-intelligent engine operable to:
extract, using an autoencoder, a set of vectorized features from the vocabulary;
categorize features included in the one or more feature sets as impacted or unimpacted;
simulate, using a quantum simulator, substantially all possible parameter and feature combinations to stabilize the impacted features when evaluated alongside the new set of guidelines;
identify a set of changes to be made to the one or more features sets based on the simulation;
grade, at a second quantum simulator, a complexity of the set of changes to made to the one or more features sets;
re-identify a set of changes to be made to the one or more features sets based on the grade;
identify, at a third quantum simulator, a degree of change compelled by the in-use computing environment to comply with the set of changes;
re-identify a set of changes to be made to the one or more features sets based on the degree of change; and
output the set of changes as a final set of changes to be made to the in-use computing environment.

14. The system of claim 13 wherein the artificially-intelligent engine is further operable to implement the final set of changes within the in-use computing environment.

15. The system of claim 13 wherein the autoencoder:
iteratively scales down each inputted element, included in a set of input elements, to a lowest dimension (referred to as, a “bottleneck layer”) and recreates each input element included in the set of input elements until the set of input elements is reproduced at an output layer of the autoencoder, and
extracts, from the bottleneck layer, the set of vectorized features.

16. The system of claim 13 wherein the autoencoder is a stacked convolutional autoencoder.

17. The system of claim 13 wherein a t-distributed stochastic neighbor embedding model within the artificially-intelligent engine categorizes the features.
